(19) United States
(12) Patent Application Publication
(10) Pub. No.: US 2018/0254637 A1
(43) Pub. Date: Sep. 6, 2018

(54) ENERGY MANAGEMENT SYSTEM AND METHOD

(71) Applicant: General Electric Company, Schenectady, NY (US)

(72) Inventors: Victor Robert ABATE, Saratoga Springs, NY (US); Keith LONGTIN, Slingerlands, NY (US)

(21) Appl. No.: 15/909,153

(22) Filed: Mar. 1, 2018

Related U.S. Application Data
(60) Provisional application No. 62/466,654, filed on Mar. 3, 2017.

(51) Int. Cl. H02J 3/38; G05B 15/02; H04L 9/06

(52) U.S. Cl. CPC H02J 3/382; G05B 15/02; H04L 67/10; H02J 3/387; H04L 9/0637

(57) ABSTRACT

An energy management system may include a plurality of energy resource systems for exchanging electric energy therebetween. According to some embodiments, each energy resource system includes a renewable energy resource to generate electric power and a power converter to convert the electric power from one form to another form. Each energy resource system may further include a local controller having a unique identification for the energy management system to control the operation of the power converter. A cloud controller may communicate with the local controller to exchange information over a communications network. The cloud controller might, for example, establish a secure connection with the local controller after verification of the unique identification and maintain at least one database to securely store information relating to energy exchanged between the plurality of energy resource systems in the form of a virtual renewable energy currency.

### CROSS-REFERENCE TO RELATED APPLICATIONS

The present application claims the benefit of U.S. Patent Application No. 62/466,654 entitled “ENERGY MANAGEMENT SYSTEM AND METHOD” and filed Mar. 3, 2017. The entire content of that application is incorporated herein by reference.

### BACKGROUND

Some embodiments described herein relate generally to an energy management system and method, and, more specifically, to energy management of a plurality of renewable energy resources.

With the rising cost and scarcity of conventional energy sources and concerns about the environment, there is a significant interest in renewable energy resources such as solar power and wind power. Wind turbine generators are regarded as environmentally friendly and relatively inexpensive alternative sources of energy that utilize wind energy to produce electrical power. Further, solar power generation uses photovoltaic (PV) modules to generate electricity from the sunlight. Since the intensity of wind and sunlight is not constant the power output of wind turbines and PV modules fluctuate throughout the day.

When wind turbines or PV modules are connected to a power grid, the power fluctuations may lead to an increase in magnitude and frequency variations in the grid voltage. These fluctuations may adversely affect the performance and stability of the overall power grid. Moreover, the power fluctuations make it difficult for the utility to plan for the energy management.

There have been efforts to utilize microgrids to solve the above-mentioned problems. A microgrid is an interconnection of small, modular generation to low voltage distribution systems. The microgrid can be connected or disconnected from the grid when required. However, as there are too many interconnections involved in the microgrid, there are protection and safety issues with the microgrid because at times there is large imbalances between the load and the generation. Moreover, as the number of interconnections increase there is an issue as to how to secure the energy transfer therein.

Therefore, a method and a system that will address the foregoing issues is desirable.

### SUMMARY

According to some embodiments, an energy management system may include a plurality of energy resource systems for exchanging electric energy therebetween. According to some embodiments, each energy resource system includes a renewable energy resource to generate electric power and a power converter to convert the electric power from one form to another form. Each energy resource system may further include a local controller having a unique identification for the energy management system to control the operation of the power converter. A cloud controller may communicate with the local controller to exchange information over a communications network. The cloud controller might, for example, establish a secure connection with the local controller after verification of the unique identification and maintain at least one database to securely store information relating to energy exchanged between the plurality of energy resource systems in the form of a virtual renewable energy currency.

Some embodiments comprise: means for scanning a unique identifier of a first energy resource system; means for determining an energy requirement of the first energy resource system; means for determining a status of a second energy resource system; means for transferring energy between the first energy resource system and the second energy resource system; means for measuring the energy transferred in terms of an amount of virtual renewable energy currency; means for transferring the amount virtual renewable energy currency along with a time stamp to a cloud controller; and means for updating the virtual renewable energy currency data of the first energy resource system and the second energy resource system if the transfer to the cloud controller is determined to be secure.

Technical effects of some embodiments of the invention are improved and computerized ways to efficiently and accurately facilitate energy management of a plurality of renewable resources. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

These and other features and aspects of embodiments of the present invention will become better understood when the following detailed description is read with reference to the accompanying drawings in which like characters represent like parts throughout the drawings, wherein:

FIG. 1 illustrates a schematic diagram representing an energy management system in accordance with some embodiments;

FIG. 2 illustrates a block diagram representing a method for energy management according to some embodiments;

FIG. 3 illustrates a schematic diagram representing a handheld device in accordance with some embodiments; and

FIG. 4 illustrates a block diagram representing a local controller according to some embodiments.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

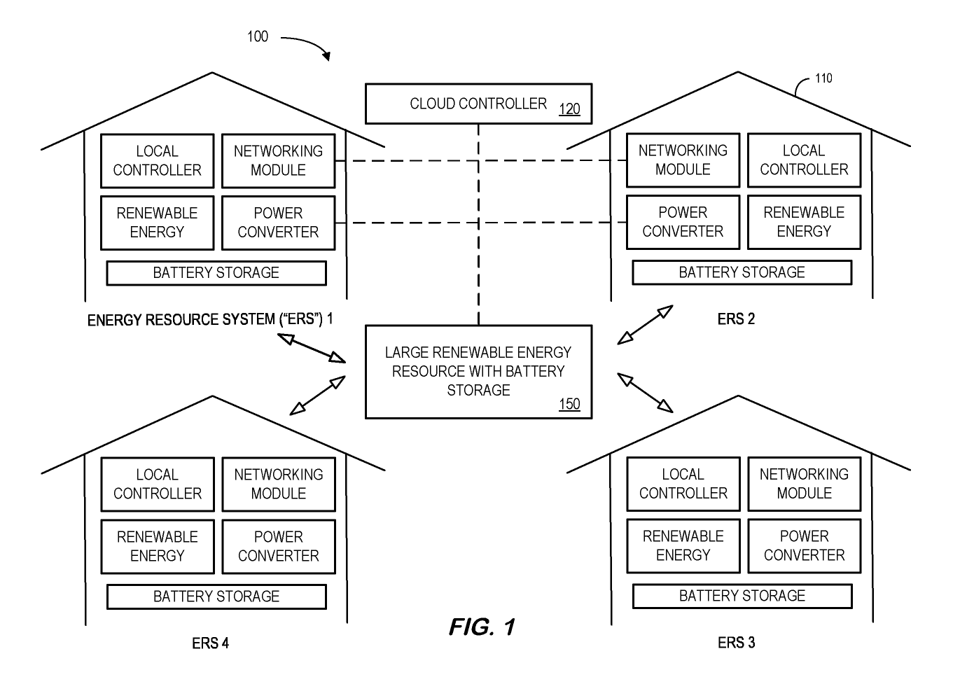

FIG. 1 shows an energy management system 100 according to aspects of the present disclosure. The energy management system 100 may be located in an area whose boundaries are defined. For example, in one embodiment, the energy management system 100 may be located in a residential community. In another embodiment, the energy management system 100 may be located in a commercial or industrial community or in yet another embodiment, the energy management system 100 may be located in an area where there are both residential as well as commercial or industrial buildings. The energy management system 100 includes a plurality of energy resource systems 110. The energy resource systems 110 may be part of the residential, commercial or industrial buildings. Furthermore, the energy resource systems 110 may be physically decoupled from the traditional power grid or, in some instances, may have a switchable connection to the power grid. In one embodiment, the energy management system 100 is completely grid independent such that the energy resource systems 110 need never to be connected to the power grid. In one embodiment, the energy resource systems 110 may be connected to each other by power lines regardless of whether the energy management system 100 is connected to the grid or grid independent.

In one embodiment, each energy resource system 110 may include a renewable energy resource to generate electric power and a power converter to convert the electric power from one form to another form. The power converter may convert the electric power from Alternating Current (“AC”) to Direct Current (“DC”) or vice versa. In another embodiment, the energy resource system 110 may include a centralized large renewable energy resource 150 with an energy storage device such as one or more batteries or Ultracapacitors. Moreover, the renewable energy resource may include a solar power module, a wind turbine, geothermal energy resources, or a fuel cell. The energy resource system 110 also includes energy storage to store the power generated by the renewable energy resource. Furthermore, the plurality of energy resource systems 110 may also include water heaters for heating water when the renewable energy resource produces excess energy and converting the stored heat energy of the water back into electric power when renewable energy resource produces less energy. In one embodiment, the water heater may be a dual-fuel water heater that operates on two different sources of energy including, for example, electricity and natural gas.

A local controller is provided in the energy resource system 110 to control the operation of the power converter. Further, a networking module is provided in the energy resource system 110 to facilitate connection with a cloud controller 120. The cloud controller 120 is communicatively coupled to the energy resource system 110 and is configured to establish a secure connection with the local controller. In one embodiment, a secure connection is established after verification of a unique identifier of the local controller or the energy resource system 110. The unique identifier verification may be performed by the cloud controller 120 in order to verify that a genuine energy resource system 110 is communicating with it and the energy resource system 110 is running trusted software, and/or is working on the behalf of a trusted user. The cloud controller 120 may verify the unique identifiers (e.g., a bar code, a RFID tag, etc.) by various techniques such as utilizing password or a thumb print, a retina scan, or another form of bio-based authentication. Further, the cloud controller 120 may maintain a database for securely storing information representing energy exchanged between the plurality of energy resource systems 110 in the form of a virtual renewable energy currency. Thus, the virtual renewable energy currency balance of a unique identifier may indicate how much energy has been received or transferred by the respective energy resource system 110. In one embodiment, the virtual renewable energy currency is referred to as British Thermal Unit (“BTU”) coins. In general, the virtual renewable energy currency provides an indication of amount of renewable energy that has been generated and utilized by the respective energy resource system 110. If an energy resource system 110 has a balance of BTU coins for example, then it may indicate that the energy resource system 110 has generated more renewable energy compared to the energy that it has consumed and the excess renewable energy has been transferred to another energy resource system 110. The owner of the energy resource system can then use those BTU coins at a later stage to receive or be granted access to renewable energy from other renewable energy resource systems 110 either within the same community or from a remote community. For example, if the owner of the energy resource system 110 is traveling to a remote location and needs additional renewable energy (e.g., to charge an electric vehicle), then the owner can apply their virtual renewable energy currency balance towards a renewable energy purchase transaction at an energy resource system 110 located in the remote community. In one embodiment, the transaction details are transmitted to the cloud controller 120 which updates the database associated with the energy resource system owner's account including, for example, their virtual renewable energy currency balance.

In one embodiment, the cloud controller 120 utilizes a block chain technology to securely store information relating to energy exchanged between the plurality of energy resource systems 110. The energy exchange transactions are time stamped and are linked to each other. Once a transaction is recorded it cannot be altered retroactively.

In one embodiment, the energy exchange between two energy resource systems 110 may be facilitated by the cloud controller 120 which sends communications to the respective two local controllers based on the energy exchange requirements of the two energy resource systems 110. For example, assume that one energy resource system 110 has a plurality of loads and at a certain time the power requirement of those plurality of loads is 2 kW. Further, assume the renewable energy resource associated with that energy resource system 110 cannot generate enough energy to meet the power requirement of the plurality of loads. In such case, the energy resource system 110 may then initiate a request to receive additional energy from another energy resource system 110 which may be facilitated by the cloud controller 120. In another embodiment, a portable energy storage device, such as an electric vehicle, may be utilized to transfer energy from one energy resource system 110 to another. For example, an electric vehicle owner may charge their vehicle batteries while connected to one energy resource system 110 and then may transfer the energy in the vehicle batteries into the battery of another energy resource system 110 within the same energy management system 100 or within a separate energy management system 100. As discussed earlier, in one embodiment the energy resource system 110 may be associated with a centralized large energy resource 150 with batteries. In one embodiment, a special-purpose battery vehicle having large arrays of rechargeable batteries or other energy storage devices may be utilized to move large quantities of renewable energy from one energy resource system 110 to another or between one energy management system 100 and another. The battery vehicle may be associated with, for example, a hybrid electric vehicle, an electric vehicle, and/or a drone. Note that the battery vehicles could be human controlled or autonomous. The autonomous vehicles could be programmed to operate in the evening to avoid quality of life disruption or to operate when demand is lower. In such case, the battery vehicles could be programmed via Global Positioning Satellite (“GPS”) systems to locate and dock with one or more charging stations associated with the large renewable energy resource 150 associated with the energy management systems 100. In one embodiment, the energy management systems 100 may be configured to send notification to one or more battery vehicles or a battery vehicle fleet, through the cloud controller 120, for example, alerting the battery vehicle fleet that the particular energy management system 100 has excess stored energy it is willing to transfer. In one embodiment, the owners of the energy resource systems 110 may be credited with an equal or pro-rata share of virtual renewable energy currency credits based on the amount of energy transferred to the battery vehicle(s).

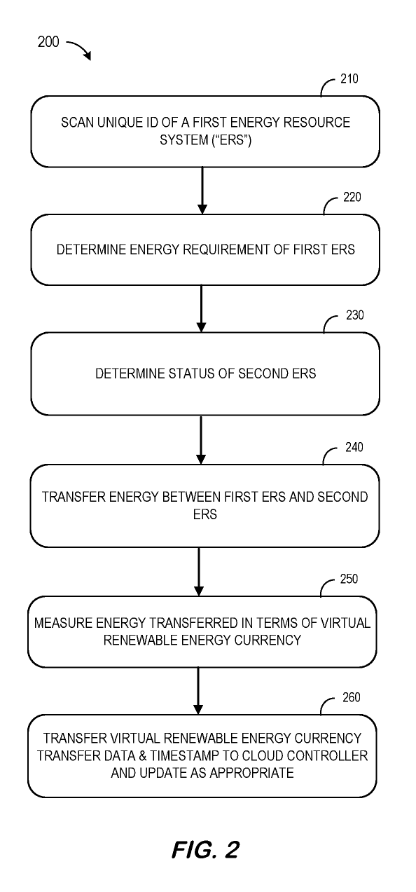

FIG. 2 shows a method 200 of energy exchange between two energy resource system according to aspects of the present disclosure. At 210, a unique identifier of the first energy resource system is read and its energy requirement is determined at 220. In one embodiment, the energy requirement may be positive or negative. A positive energy requirement indicates an excess of energy at the energy resource system whereas a negative energy requirement indicates a lack of energy or requirement of more energy at the place where the energy resource system is located. A unique identifier and status of a second energy resource system is the determined at 230. Once the unique identifiers are verified with the cloud controller and if the energy requirement at the second energy resource system is found to be sufficient to match the energy requirements of the first energy resource system, energy is transferred between the two energy resource systems at 240. The energy transfer may be facilitated by the power converter and the local controller after the local controller receives a signal from the cloud controller. For example, in one embodiment, the voltage of the power converters of the sending energy resource system and the receiving energy resource system may be adjusted in order to transfer energy/power therebetween. The energy exchanged between the two energy resource systems is measured at 250 and transferred to the cloud controller in terms of virtual renewable energy currency. The record of the first and the second energy resource systems may then be updated by the cloud controller at 260 to keep the respective accounts up to date. In one embodiment, the local controller may itself track and control energy usage of the energy resource system as well as energy transfer of the energy resource system.

In one embodiment, the energy transfer between the plurality of energy resource systems is based on demand curves and/or energy consumption limits of the energy resource systems. In yet another embodiment, the energy transfer may be based on the time of the day or other conditions prevalent at the time of transaction. In one embodiment, the various seasons as well as geographic location at the community where the plurality of energy resource systems are located are also the factors which are taken into consideration with respect to the energy transfer mechanism. For example, the earth's axis of rotation is titled about 23.5 degrees compared to the plane of the earth's orbit around the sun. Therefore, when the Northern Hemisphere is facing the sun, the Southern Hemisphere is tilted away from the sun. This leads to summer in the Northern Hemisphere and winter in the Southern Hemisphere as the Northern Hemisphere experiences the most direct sunlight and solar heating which results in more solar power generation in Northern Hemisphere. In one embodiment, the energy management mechanism may utilize machine learning techniques or other algorithms that uses the factors mentioned above and facilitates energy transfer between the plurality of energy resource systems. For example, the energy transfer mechanism may utilize power generation forecasting or load forecasting algorithms based on which the energy transfer between two energy resource systems could be planned.

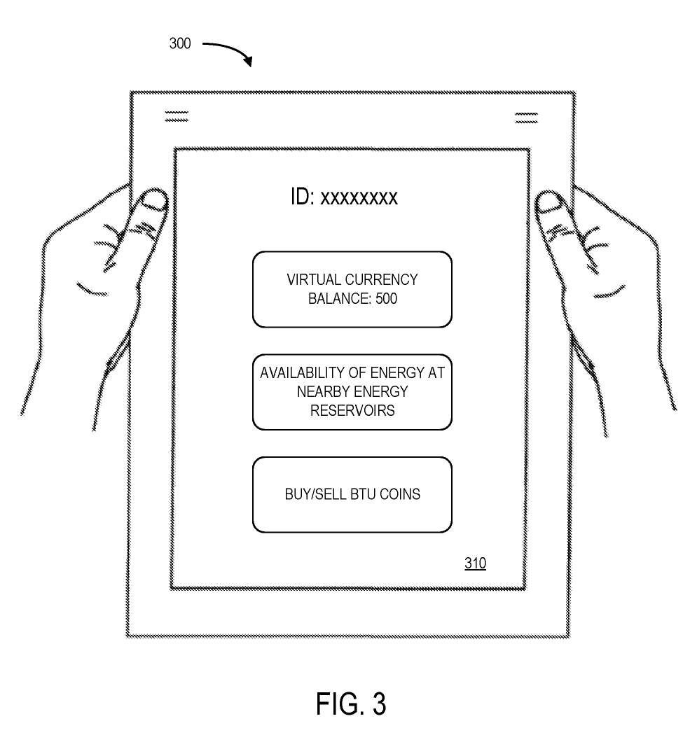

In one embodiment, the energy exchange transaction from the energy resource system to the battery vehicle may be facilitated by a handheld device which is configured to read the identification tags of the local controller. The identification tags may include, for example, radio frequency identification (RFID) tags. FIG. 3 shows one such handheld device 300. The handheld device 300 may be a mobile phone or any other personal electronic device with an energy management application installed therein. The handheld device 300 may exchange information with the cloud controller to facilitate the energy exchange transaction between the energy resource system and the battery vehicle or the between the two energy resource systems. The handheld device 300 may also be connected with the local controller by other means such as by Bluetooth syncing. The handheld device 300 may utilize a display 310 to provide other information such as virtual currency balance, and availability or requirement of energy at nearby energy resource systems. Further, the handheld device 300 may provide an option to buy or sell the virtual currency. In one embodiment, the virtual currency may be used to receive energy or may be donated to a charity outside of the area where the energy management system is located.

In yet another embodiment, the community where the energy management system is located may partner with Electric Vehicle (“EV”) companies for energy transfer transactions. For example, during the night time, when the energy requirement at the energy management system is low due to reduced loads, all the excess energy in a community may be transmitted to the EV batteries by providing a plurality of EV charging plug and play interfaces. The energy transfer from the energy management system to the EV batteries may be facilitated by a signal from the cloud controller to the local controller. Once the local controller receives the energy transfer signal then the local controller can control the power converter such that the power converter supplies higher current to charge the EV batteries.

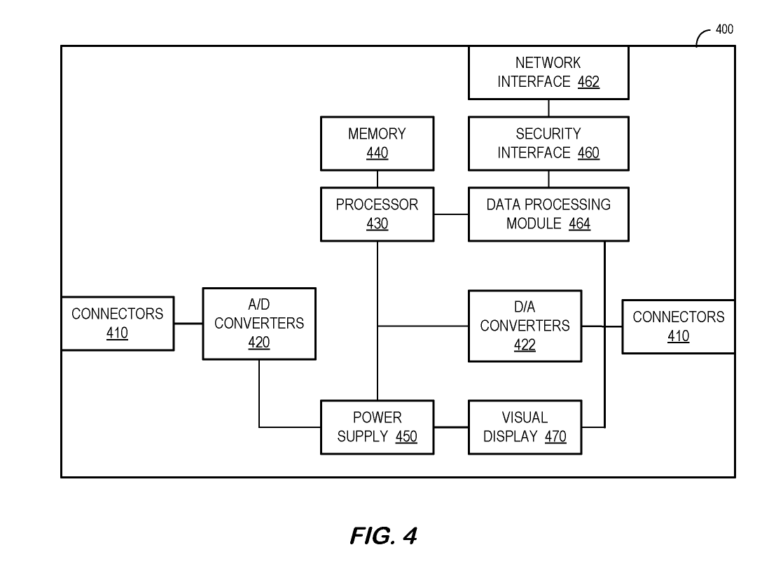

Referring now to FIG. 4, there is shown a block diagram illustrating one embodiment of a local controller 400 as used in the energy management system. In particular, the local controller includes each of the following elements: a plurality of connectors 410 for receiving external inputs; an analog to digital converter 420 for converting received analog signals into digital signals; a processing unit 430 for performing any signal processing required by the local controller 400; a memory 440 operatively connected to the processor 430 for storing information on the local controller 400; a power supply 450 for providing required power to the processor 430 and other elements; a security interface 460, a network interface 462, and a data processing module 464 for enabling transmission and receipt of information to the cloud controller and/or other local controllers; and a visual display 470 for enabling the local controller 400 to indicate current status or other information visually. The local controller 400 may also include a digital to analog converter 422 for converting digital signals into analog signals to control the power converters.

This written description uses examples to explain the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An energy management system, comprising:
a plurality of energy resource systems for exchanging electric energy therebetween, wherein each of the energy resource system comprises:
a renewable energy resource to generate electric power,
a power converter to convert the electric power from one form to another form, and
a local controller having a unique identification for the energy management system to control the operation of the power converter; and
a cloud controller to communicate with the local controller to exchange information over a communications network, wherein the cloud controller establishes a secure connection with the local controller after verification of the unique identification, and further wherein the cloud controller maintains at least one database to securely store information relating to energy exchanged between the plurality of energy resource systems in the form of a virtual renewable energy currency.

2. The energy management system of claim 1, wherein the cloud controller utilizes a block chain technology to securely store information relating to energy exchanged between the plurality of energy resource systems.

3. The energy management system of claim 2, wherein the block chain technology utilizes time stamped energy exchange transactions which are linked to each other.

4. The energy management system of claim 1, wherein the plurality of energy resource systems is not connected to the grid.

5. The energy management system of claim 1, wherein the energy exchange between the plurality of energy resource systems is facilitated by a battery vehicle.

6. The energy management system of claim 5, wherein the battery vehicle is associated with at least one of: (i) a hybrid electric vehicle, (ii) an electric vehicle, (iii) an autonomous vehicle, and (iv) a drone.

7. The energy management system of claim 1, wherein the unique identification of the local controller is provided via a Radio Frequency Identification (“RFID”) tag.

8. The energy management system of claim 7 further comprising a handheld device configured to read the RFID tags of the local controller and communicate with the cloud controller.

9. The energy management system of claim 8, wherein the handheld device is configured to provide a virtual renewable energy currency balance of the local controller.

10. The energy management system of claim 8, wherein the handheld device is configured to provide information about available energy at the plurality of energy resource systems.

11. The energy management system of claim 8, wherein the handheld device includes a mobile phone having an energy management application installed therein.

12. The energy management system of claim 1, wherein the plurality of energy resource systems are associated with at least one of: (i) residential communities, and (ii) commercial communities.

13. The energy management system of claim 1, wherein the plurality of energy resource systems are coupled to each other by power lines.

14. The energy management system of claim 1, wherein the renewable energy resource includes at least one of: (i) a solar power module, (ii) a wind turbine, (iii) geothermal energy resources, and (iv) a fuel cell.

15. The energy management system of claim 1, wherein the plurality of energy resource systems includes water heaters for heating water when the renewable energy resource produces excess energy and converting the water heat back into electric power when renewable energy resource produces less energy.

16. The energy management system of claim 1, wherein the energy transfer between the plurality of energy resource systems is based on at least one of: (i) demand curves, (ii) energy consumption limits, and (iii) a time of the day.

17. The energy management system of claim 1, wherein the energy transfer between the plurality of energy resource systems is based on seasons at the community and geographic location of the community where the plurality of energy resource systems are located.

18. The energy management system of claim 1, wherein the virtual renewable energy currency comprises a British Thermal Unit (“BTU”) coin.

19. An energy management method, comprising:
scanning a unique identifier of a first energy resource system;
determining an energy requirement of the first energy resource system;
determining a status of a second energy resource system;
transferring energy between the first energy resource system and the second energy resource system;
measuring the energy transferred in terms of an amount of virtual renewable energy currency;
transferring the amount virtual renewable energy currency along with a time stamp to a cloud controller; and
updating the virtual renewable energy currency data of the first energy resource system and the second energy resource system if the transfer to the cloud controller is determined to be secure.

20. The method of claim 19, wherein the energy transferred between the first energy resource system and second energy resource system is facilitated by a battery vehicle.
